(19) United States
(12) Patent Application Publication
(10) Pub. No.: US 2009/0219275 A1
(43) Pub. Date: Sep. 3, 2009

(54) DC-DC CONVERTER AND ORGANIC LIGHT EMITTING DISPLAY USING THE SAME

(76) Inventor: Sang-Bong Jeon, Suwon-si (KR)

Correspondence Address: CHRISTIE, PARKER & HALE, LLP, PO BOX 7068, PASADENA, CA, 91109-7068, US

(21) Appl. No.: 12/249,784

(22) Filed: Oct. 10, 2008

(30) Foreign Application Priority Data
Feb. 28, 2008 (KR) 10-2008-0018314

(51) Int. Cl. H01F 38/00; G09G 5/00

(52) U.S. Cl. 345/212; 323/355

(57) ABSTRACT

A DC-DC converter is provided including a switch unit, a coil, and a controller. The switch unit is coupled to an input power supply and is configured to transmit or not to transmit input power from the input power supply in accordance with a switching signal. The coil has a first terminal for receiving current output from the switch unit and a second terminal. The controller is coupled to the coil and is configured to operate or not to operate in accordance with an enable signal. The controller is configured to change a flow of current through the coil such that the second terminal of the coil is at a higher voltage than the first terminal of the coil.

### CROSS-REFERENCE TO RELATED APPLICATIONS

This application claims priority to and the benefit of Korean Patent Application No. 10-2008-0018314, filed on Feb. 28, 2008, in the Korean Intellectual Property Office, the entire content of which is incorporated herein by reference.

### BACKGROUND OF THE INVENTION

1. Field of the Invention

The present invention relates to a direct current to direct current (DC-DC) converter and an organic light emitting display using the same, and more particularly to a DC-DC converter with decreased power consumption and an organic light emitting display using the same.

2. Description of Related Art

Recently, various flat panel displays have been developed with reduced weight and volume. The flat panel displays include a liquid crystal display, a field emission display, a plasma display panel, an organic light emitting display, and the like.

Among others, the organic light emitting display displays an image using organic light emitting diodes (OLEDs) for generating light as a result of the recombination of electrons and holes.

The OLED includes an anode electrode, a cathode electrode, and a light emitting layer positioned therebetween. If current flows in a direction from the anode electrode to the cathode electrode, the OLED emits light to represent colors.

The organic light emitting display has various advantages such as an excellent color representation and a thin thickness so that it is widely used in a variety of applications, e.g., a PDA, an MP3, a monitor, and a TV, in addition to a cellular phone.

When the organic light emitting display is used in a mobile device such as a cellular phone, a PDA, or an MP3 player, the organic light emitting display may be supplied power through a battery. However, if an amount of current consumed in the organic light emitting display is large, the mobile device cannot be used for a long time and the battery should be frequently exchanged. Therefore, it is desirable to reduce current consumption in the organic light emitting display.

### SUMMARY OF THE INVENTION

A DC-DC converter and an organic light emitting display using the same are provided with reducing leakage currents and therefore decreased power consumption.

In an exemplary embodiment of the present invention, a DC-DC converter is provided including a switch unit, a coil, and a controller. The switch unit is coupled to an input power supply and is configured to transmit or not to transmit input power from the input power supply in accordance with a switching signal. The coil has a first terminal for receiving current output from the switch unit and a second terminal. The controller is coupled to the coil and is configured to operate or not to operate in accordance with an enable signal. The controller is configured to change a flow of current through the coil such that the second terminal of the coil is at a higher voltage than the first terminal of the coil.

In one exemplary embodiment, the switching signal and the enable signal are synchronized with each other.

In one exemplary embodiment, the switch unit switches the input power in accordance with the switching signal.

In one exemplary embodiment, the switch unit includes a first input terminal coupled to the input power supply and a second input terminal for receiving the switching signal; a first switch having a first electrode coupled to the first input terminal, a second electrode coupled to a ground, and a gate coupled to the second input terminal; and a second switch having a first electrode coupled to the first input terminal, a second electrode coupled to an output terminal, and a gate coupled to the first input terminal through a resistor.

In one exemplary embodiment, the input power supply comprises a battery.

In an exemplary embodiment of the present invention, an organic light emitting display is providing including a display unit for displaying an image corresponding to a data signal and a scan signal; a data driver for providing the data signal to the display unit; a scan driver for providing the scan signal to the display unit; and a DC-DC converter for transferring driving power to the data driver and to the scan driver. The DC-DC converter includes a switch unit coupled to an input power supply and configured to transmit or not to transmit input power from the input power supply in accordance with a switching signal; a coil having a first terminal for receiving current output from the switch unit and a second terminal; and a controller coupled to the coil and configured to operate or not to operate in accordance with an enable signal, the controller configured to change a flow of current through the coil such that the second terminal of the coil is at a higher voltage than the first terminal of the coil.

### BRIEF DESCRIPTION OF THE DRAWINGS

The accompanying drawings, together with the specification illustrate exemplary embodiments of the present invention and serve to explain the principles of the present invention:

FIG. 1 is a block diagram of an organic light emitting display according to an exemplary embodiment of the present invention;

FIG. 2 is a circuit diagram showing a first exemplary embodiment of the DC-DC converter of FIG. 1;

FIG. 3 is a circuit/block diagram showing a second exemplary embodiment of the DC-DC converter of FIG. 1; and

FIG. 4 is a circuit diagram showing the switch unit of FIG. 3.

### DETAILED DESCRIPTION

Hereinafter, certain exemplary embodiments according to the present invention will be described with reference to the accompany drawings. Herein, when a first element is described as being coupled to a second element, the first element may be directly coupled to the second element or indirectly coupled to the second element via a third element. Further, some of the elements that are not essential to the complete understanding of the invention are omitted for clarity. Also, like reference numerals may refer to like elements throughout.

Hereinafter, exemplary embodiments according to the present invention will be described with reference to the accompanying drawings.

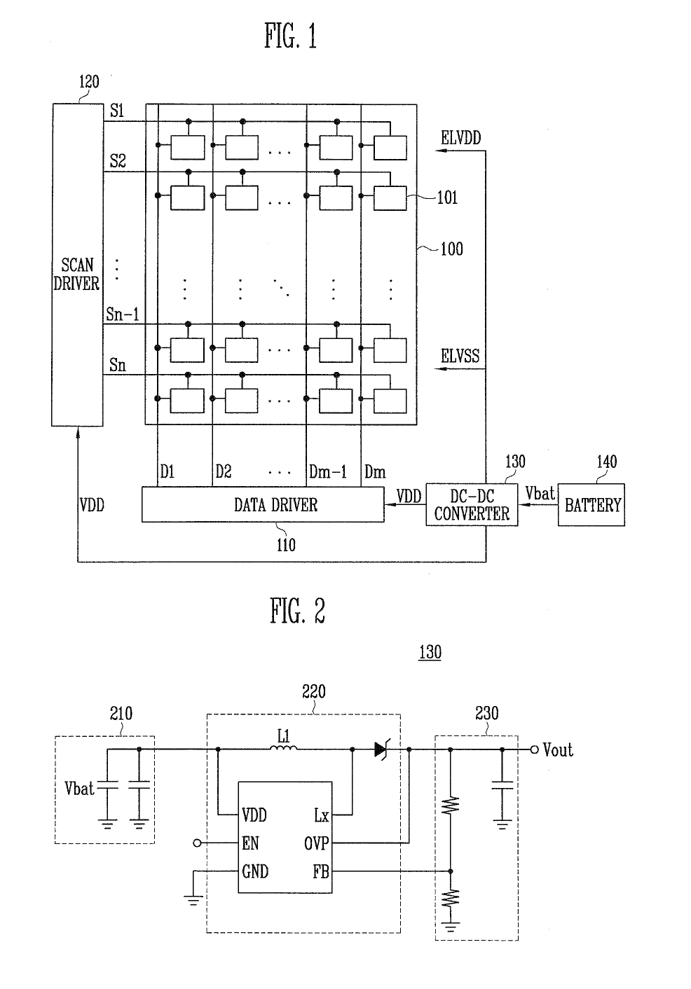

FIG. 1 is a block diagram of an organic light emitting display according to an exemplary embodiment of the present invention. The organic light emitting display according to an exemplary embodiment of the present invention includes a display unit 100, a data driver 110, a scan driver 120, a DC-DC converter 130, and a battery 140.

The display unit 100 includes a plurality of pixels 101, wherein each pixel 101 includes an OLED for emitting light corresponding to a flow of current. The display unit 100 is arranged with a plurality of scan lines S1, S2, . . . , Sn-1, and Sn extending in a row direction for transferring scan signals, and a plurality of data lines D1, D2, . . . , Dm-1, and Dm extending in a column direction for transferring data signals. Also, the display unit 100 receives first power ELVDD and second power ELVSS.

The data driver 110 receives RGB video data having red, blue, and green components to generate data signals. Further, the data driver 110 applies the generated data signals to the display unit 100 via the coupled data lines D1, D2, . . . , Dm-1, and Dm.

The scan driver 120 transfers the scan signals to a specific row of the display unit 100. The scan driver 120 applies the generated scan signals to the display unit 100 via the coupled scan lines S1, S2, . . . , Sn-1, and Sn. The pixel 101 receives the scan signals output from the scan driver 120 and the data signals output from the data driver 110, and a driving current is generated in the pixel 101 for the OLED.

The DC-DC converter 130 transfers the first power ELVDD and the second power ELVSS to the display unit 100, and transfers driving voltage VDD to the data driver 110 and the scan driver 120. The DC-DC converter 130 boosts and/or inverts voltage Vbat input from the battery 140 to generate the first power ELVDD and the second power ELVSS.

The battery 140 supplies current having a voltage (e.g., a predetermined voltage) to the DC-DC converter 130 for a time period (e.g., a predetermined time period) to enable the organic light emitting display to be used without being coupled to a separate external power source.

FIG. 2 is a circuit diagram showing a first exemplary embodiment of the DC-DC converter of FIG. 1. The DC-DC converter 130 includes an input terminal 210, an output terminal 230, and a controller 220 coupled therebetween.

The input terminal 210 is coupled to battery 140 to receive input power from the battery 140. The controller 220 includes a coil L1 and generates electromotive force from the coil L1 by switching power transferred from the input terminal 210. The operation or non-operation of the controller 220 is controlled by an enable signal EN. The output terminal 230 receives current generated from the coil L1 and outputs the current.

If the operation of the controller 220 is stopped using the enable signal EN in order to stop the operation of the DC-DC converter 130, the operation to block or to pass the current flowing through the coil L1 is stopped. Because the current output from the battery 140 is direct current, the coil L1 functions as a wire. Therefore, the current from the battery 140 passes through the coil L1 to be output to the output terminal 230.

If the current is output through the output terminal 230, the current is transferred to the data driver 110 and/or the scan driver 120 and the transferred current flows through the data driver 110 and/or the scan driver 120.

Therefore, the current stored in the battery 140 is continuously consumed. Thus, the current charged in the battery 140 is consumed even when the organic light emitting display is not used so that use time of the organic light emitting display is shortened.

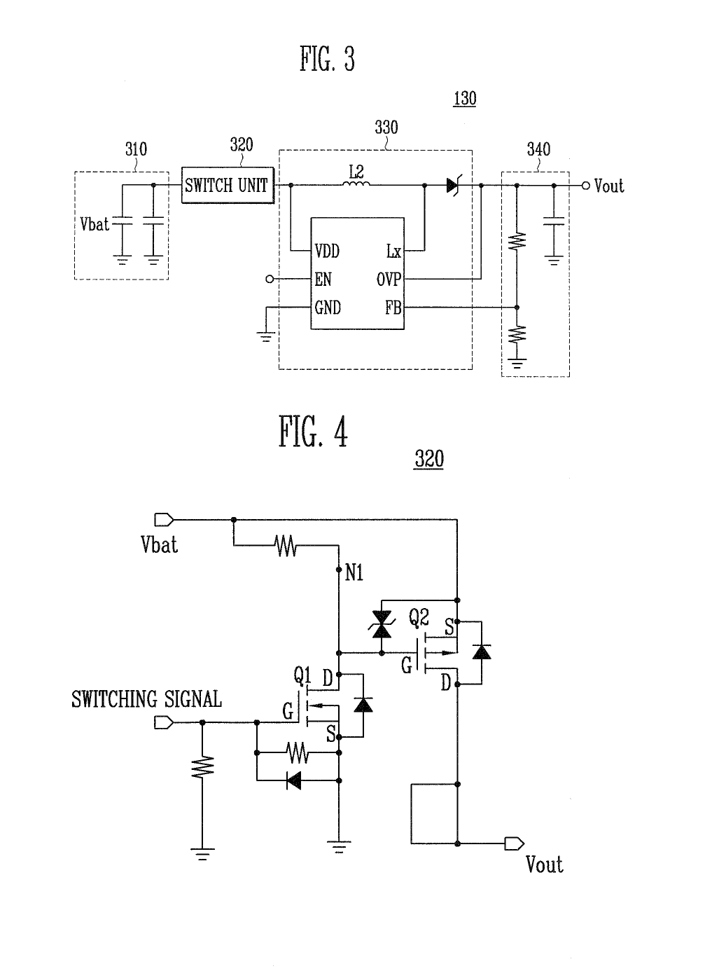

FIG. 3 is a circuitblock diagram showing a second exemplary embodiment of the DC-DC converter of FIG. 1. The DC-DC converter 130 includes an input terminal 310, a controller 330, an output terminal 340, and a switch unit 320.

The input terminal 310 is coupled to battery 140 to receive input power from the battery 140. The controller 330 includes a coil L2 and generates electromotive force from the coil L2 by switching power transferred from the input terminal 310. The operation or non-operation of controller 330 is controlled through an enable signal EN. The output terminal 340 receives current generated from the coil L2 and outputs the current.

The switch unit 320 is coupled between the input terminal 310 and the controller 330 of the DC-DC converter 130. In other words, the current output from the battery 140 is blocked from passing through the switch unit 320 or is allowed to pass through the switch unit 320. If the current output from the battery 140 is allowed to pass through the switch unit 320, the current is provided to the coil L2 of the DC-DC converter 130. Switch unit 320 receives a switching signal synchronized with the enable signal EN to perform a switching operation. Therefore, if the controller 330 operates by the enable signal EN, the switch unit 320 is turned on by the switching signal to transfer power from the battery 140 to the coil L2. If the operation of the controller 330 is stopped by the enable signal EN, the switch unit is turned off by the switching signal to block power output from the battery 140, thereby preventing the power output from the battery 140 from being transferred to the coil L2. Therefore, when the operation of the controller 330 stops, the current generated from the battery 140 can be prevented from flowing through the coil L2 so that power consumption in the organic light emitting display is reduced.

FIG. 4 is a circuit diagram showing the switch unit of FIG. 3. The switch unit 320 includes a first switch Q1 and a second switch Q2.

A drain of the first switch Q1 is coupled to a first node N1, a source of the first switch Q1 is coupled to a ground voltage, and a gate of the first switch Q1 is coupled to a switching signal such that the first switch Q1 performs a switching operation by the switching signal. The first switch Q1 is implemented as an NMOS transistor.

If the switching signal is input in a high state, the first switch Q1 is turned on. Accordingly, the first node N1 is coupled to the ground voltage so that voltage of the first node N1 becomes the ground voltage. Because the enable signal EN is synchronized with the switching signal, the enable signal EN becomes a high state and the controller 330 therefore operates. If the switching signal is input in a low state, the first switch Q1 is turned off so that the first node N1 becomes the voltage Vbat of the battery 140. Because the enable signal EN is synchronized with the switching signal, the enable signal EN becomes a low state and the operation of the controller 330 therefore stops.

A source of the second switch Q2 is coupled to the battery 140 to receive voltage Vbat from the battery 140, a drain of the second switch Q2 is coupled to an output terminal Vout, and a gate of the second switch Q2 is coupled to the first node N1. The second switch Q2 is implemented as a PMOS transistor.

If the voltage of the first node N1 becomes the ground voltage by the first switch Q1, the second switch Q2 is turned on. If the voltage of the first node N1 becomes the voltage Vbat of the battery, the second switch Q2 is turned off. In other words, the second switch Q2 is turned on if the switching signal is in a high state, and the second switch Q2 is turned off if the switching signal is in a low state.

If the second switch Q2 is turned on, power is transferred from the battery 140 to the output terminal Vout. If the second switch Q2 is turned off, power from the battery 140 is blocked from being provided to the output terminal Vout.

Therefore, when the controller 330 operates, the switch unit 320 transfers power from the battery 140 to the coil L2. When the controller 330 does not operate, the switch unit 320 prevents power from the battery 140 from being transferred to the coil L2. Therefore, power consumption is reduced by reducing a leakage current (i.e., current consumption).

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A DC-DC converter, comprising:
a switch unit coupled to an input power supply and configured to transmit or not to transmit input power from the input power supply in accordance with a switching signal;
a coil having a first terminal for receiving current output from the switch unit and a second terminal; and
a controller coupled to the coil and configured to operate or not to operate in accordance with an enable signal, the controller configured to change a flow of current through the coil such that the second terminal of the coil is at a higher voltage than the first terminal of the coil.

2. The DC-DC converter as claimed in claim 1, wherein the switching signal and the enable signal are synchronized with each other.

3. The DC-DC converter as claimed in claim 2, wherein the switch unit switches the input power in accordance with the switching signal.

4. The DC-DC converter as claimed in claim 2, wherein the switch unit comprises:
a first input terminal coupled to the input power supply and a second input terminal for receiving the switching signal;
a first switch having a first electrode coupled to the first input terminal, a second electrode coupled to a ground, and a gate coupled to the second input terminal; and
a second switch having a first electrode coupled to the first input terminal, a second electrode coupled to an output terminal, and a gate coupled to the first input terminal through a resistor.

5. The DC-DC converter as claimed in claim 1, wherein the input power supply comprises a battery.

6. An organic light emitting display, comprising:
a display unit for displaying an image corresponding to a data signal and a scan signal;
a data driver for providing the data signal to the display unit;
a scan driver for providing the scan signal to the display unit; and
a DC-DC converter for transferring driving power to the data driver and to the scan driver,
wherein the DC-DC converter comprises:
a switch unit coupled to an input power supply and configured to transmit or not to transmit input power from the input power supply in accordance with a switching signal;
a coil having a first terminal for receiving current output from the switch unit and a second terminal; and
a controller coupled to the coil and configured to operate or not to operate in accordance with an enable signal, the controller configured to change a flow of current through the coil such that the second terminal of the coil is at a higher voltage than the first terminal of the coil.

7. The organic light emitting display as claimed in claim 6, wherein the switching signal and the enable signal are synchronized with each other.

8. The organic light emitting display as claimed in claim 7, wherein the switch unit switches the input power in accordance with the switching signal.

9. The organic light emitting display as claimed in claim 7, wherein the switch unit comprises:
a first input terminal coupled to the input power supply and a second input terminal for receiving the switching signal;
a first switch having a first electrode coupled to the first input terminal, a second electrode coupled to a ground, and a gate coupled to the second input terminal; and
a second switch having a first electrode coupled to the first input terminal, a second electrode coupled to an output terminal, and a gate coupled to the first input terminal through a resistor.

10. The organic light emitting display as claimed in claim 6, wherein the input power supply comprises a battery.
